(19) United States
(12) Patent Application Publication
(10) Pub. No.: US 2016/0361740 A1
(43) Pub. Date: Dec. 15, 2016

(54) GEOMEMBRANE WITH BARRIER LAYERS FOR ODOR CONTROL APPLICATIONS

(71) Applicants: Peixiang Xing, Sioux Falls, SD (US); Kun Liang, Sioux Falls, SD (US)

(72) Inventors: Peixiang Xing, Sioux Falls, SD (US); Kun Liang, Sioux Falls, SD (US)

(21) Appl. No.: 15/176,999

(22) Filed: Jun. 8, 2016

Related U.S. Application Data
(60) Provisional application No. 62/172,981, filed on Jun. 9, 2015.

(51) Int. Cl. B08B 15/00; B32B 27/32; C02F 1/58; B32B 27/08; B32B 5/10; B32B 27/34; B32B 7/12

(52) U.S. Cl. CPC B08B 15/00; B32B 27/34; B32B 27/32; B32B 7/12; B32B 27/08; B32B 5/10; C02F 1/58; B32B 2307/308; B32B 2307/7248; C02F 2303/02; C02F 2101/101

(57) ABSTRACT

A geomembrane comprises one or more non-polar layers formed predominantly from a non-polar material, at least one polyamide polar layer formed predominantly from a polyamide material, and at least one tie layer disposed on either side of the at least one polyamide polar layer and between the one or more non-polar layers and the at least one polyamide polar layers, wherein each tie layer bonds to one of the one or more non-polar layers and to one of the at least one polyamide polar layer.

### CROSS-REFERENCE TO RELATED APPLICATION

This application claims priority to U.S. Provisional Application No. 62/172,981, titled “GEOMEMBRANE WITH BARRIER LAYERS FOR ODOR CONTROL APPLICATIONS,” filed on Jun. 9, 2015, the disclosure of which is incorporated herein by reference as if reproduced herein in its entirety.

### BACKGROUND

Membranes can be used to provide a barrier between ground soil and other substances. These membranes, also referred to as geomembranes, have been used to prevent chemicals from seeping into or out of soil or water. For example, Geomembranes have been used for covering water that has been known to emit odors, such as industrial wastewater, for odor control.

Geomembranes have been made with one or more non-polar layers, such as one or more polyethylene layers, to provide a barrier to water and other polar compounds. Polar materials, such as ethylene vinyl alcohol (EVOH), have also been used to provide a barrier to non-polar compound, such as methane, radon, and benzene.

### SUMMARY

The present disclosure describes a geomembrane configured to reduce long-term breakdown of the bond formed between a tie layer and a polar layer of the geomembrane through the use of one or more polyamides as the polar layer.

The present disclosure describes a geomembrane comprising one or more non-polar layers formed predominantly from a non-polar material, at least one polyamide polar layer formed predominantly from a polyamide material, and tie layers disposed on either side of the at least one polyamide polar layer and between the one or more non-polar layers and the at least one polyamide polar layers, wherein the tie layer bonds to the one or more non-polar layers and the one or more polyamide polar layers.

The present disclosure also describes a geomembrane comprising a pair of non-polar layers formed predominantly from polyethylene, at least one polyamide layer positioned between the pair of non-polar layers, and a pair of tie layers disposed on either side of the at least one polyamide layer, each tie layer being positioned between the at least one polyamide layer and a corresponding one of the pair of non-polar layers, the tie layers each comprising a maleic anhydride-grafted polyethylene that bonds to the polyethylene of the non-polar layer and the at least one polyamide layer.

The present disclosure also describes a method of providing a barrier for odor control, the method comprising covering a pool of water with one or more geomembranes so that the one or more geomembranes are in contact with at least a portion of the pool of water, wherein the pool of water has a temperature of at least 95° C. for at least a portion of the time that it is covered by the one or more geomembranes, with each of the one or more geomembranes comprising one or more non-polar layers formed predominantly from a non-polar material, at least one polyamide polar layer formed predominantly from a polyamide material, and tie layers disposed on either side of the at least one polyamide polar layer and between the one or more non-polar layers and the at least one polyamide polar layers, wherein the tie layer bonds to the one or more non-polar layers and the one or more polyamide polar layers.

### BRIEF DESCRIPTION OF THE FIGURES

FIG. 1 is a cross-sectional side view of an example geomembrane.

FIG. 2 is a cross-sectional side view of an example geomembrane with textured surfaces on both sides of the geomembrane.

FIG. 3 is a cross-sectional side view of an example geomembrane with a smooth surface on one side and a textured surface on the other side of the geomembrane.

FIG. 4 is a cross-sectional side view of a reinforced barrier structure with a reinforcing fabric in contact with an outer surface of an example geomembrane.

FIG. 5 is a top view of a plurality of geomembranes welded together for use in covering at least a portion of a structure, such as a wastewater treatment pool.

### DETAILED DESCRIPTION

In the following Detailed Description, reference is made to the accompanying drawings which form a part hereof. The drawings show, by way of illustration, specific examples of geomembranes. These examples are described in sufficient detail to enable those skilled in the art to practice, and it is to be understood that other embodiments can be utilized and that structural changes can be made without departing from the scope of the present disclosure. Terms indicating direction, such as front, rear, left, right, up, and down, are generally used only for the purpose of illustration or clarification and are not intended to be limiting. The following Detailed Description is not to be taken in a limiting sense, and the scope of the present disclosure is defined by the appended claims and their equivalents.

This disclosure describes geomembranes, for example that can be used to prevent the release of chemical compounds into the air. For example, the geomembranes described herein can be used to provide a barrier to odor-causing compounds from systems or processes where odor is common, such as industrial wastewater treatment facilities.

As described above, geomembranes have been made that include non-polar layers, such as one or more polyethylene (PE) layers, to provide a barrier to water and other polar compounds, and one or more polar layers, such as one or more ethylene vinyl alcohol (EVOH) layers, to provide a barrier to methane and other non-polar compounds. Typically polar molecules, such as EVOH do not bond directly to non-polar molecules, such as PE. Therefore, in order to produce a geomembrane that can provide a barrier to both polar and non-polar pollutants, the one or more polar layers can be joined to the one or more non-polar layers with one or more tie layer. For example, one or more polyethylene layers can be joined to one or more polar layers with a polyethylene grafted with maleic anhydride. The bonding can occur due to reaction between the maleic anhydride grafts and the polar material, such as EVOH, to form ester bonds therebetween. In environments where the geomembrane will be exposed to water or high relative humidity and at elevated temperatures, such as those experienced by geomembranes when covering industrial wastewater, the bonds between tie layers and the polar layers can break down relatively rapidly. It is not uncommon for industrial wastewater that is being treated to reach temperatures as high as 90° C., such as 95° C. or higher. Therefore, for these applications, the bonds between the tie layers and the polar layers of a geomembrane must be able to withstand temperatures of at least 90° C., such as at least 95° C., and a relative humidity of at least 90%, such as at least 95%, for example 100%.

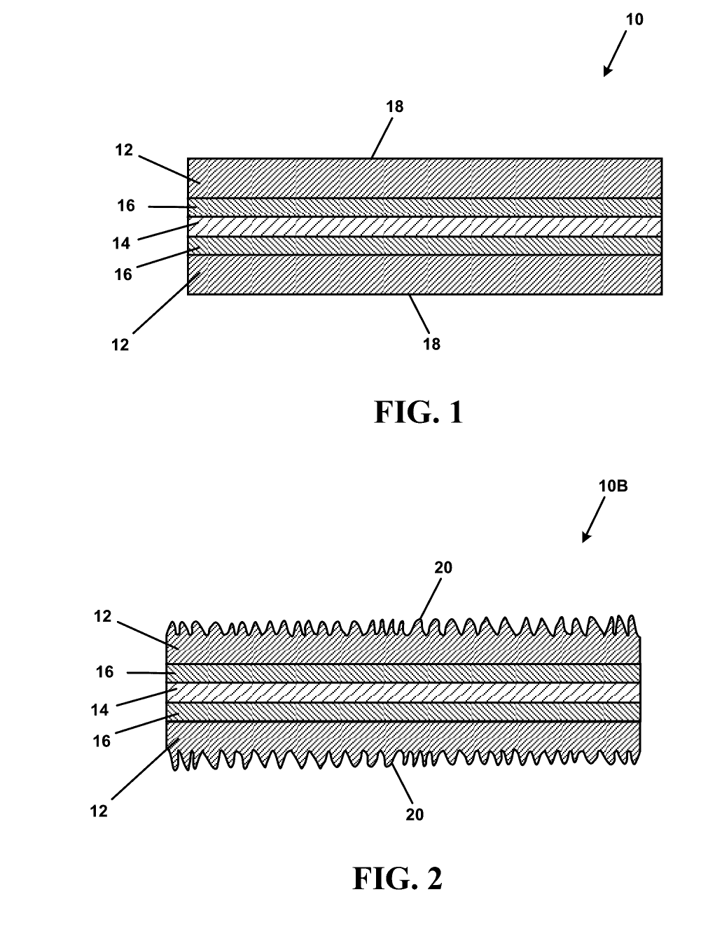

FIG. 1 shows a cross-sectional side view of an example geomembrane 10. The geomembrane 10 can provide a barrier to water or water vapor and to one or more compounds that produce odors. Examples of odor-producing compounds, also referred to herein as “odor compounds,” can include, but are not limited to, one or more of odor-causing volatile organic compounds (VOCs), such as hydrogen sulfide, benzene, toluene, dichlorobenzene, and methane.

The geomembrane 10 includes one or more layers configured to provide a barrier to one or more compounds or compositions to which the geomembrane 10 is intended to provide a barrier. The geomembrane 10 can include one or more generally non-polar layers 12, each formed predominantly from a non-polar material. The non-polar material of the non-polar layers 12 can comprise a polyolefin, such as polyethylene (PE) or polypropylene (PP). Each of the one or more non-polar layers 12 can be formed entirely or substantially entirely with polyethylene and will sometimes be referred to herein as a polyethylene layer 12 for the sake of brevity.

The use of a generally non-polar material, such as polyethylene, can allow the geomembrane 10 to provide a barrier to polar materials, such as water (H₂O). The one or more non-polar layers 12 can also provide a barrier to polar odor compounds, such as hydrogen sulfide (H₂S), or other polar pollutants, either alone or dissolved in water or another polar solvent. Polyolefins, such as polyethylene can also provide for relatively high impact strength and resistance to tearing, in particular if a relatively low-density polyolefin is used. Examples of low-density polyolefins that can be used include, but are not limited to, one or more of low-density polyethylene (LDPE), linear low-density polyethylene (LLDPE), metallocene linear low-density polyethylene (mLLDPE), very-low density polyethylene (VLDPE), or ultra-low density polyethylene (ULDPE) plastomer polymers, or polyolefins other than polyethylene with similar densities. Other densities of polyethylene or other non-polar materials can be used, such as medium density polyethylene (MDPE) or high-density polyethylene (HDPE).

The non-polar materials of the one or more non-polar layers 12, such as polyethylene, are known, however, to have generally poor barrier properties with respect to gases, such as oxygen gas (O₂), or to non-polar materials, such as VOCs and other non-polar odor compounds. In order to also provide a barrier to non-polar materials or gases including non-polar odor compounds, the geomembrane 10 can include one or more generally polar layers 14. Each polar layer 14 can be formed predominantly from a polar material capable of providing a barrier to non-polar compounds, such as one or more polyamides (also referred to as one or more nylons). As described in more detail below, the present inventors have discovered that when the one or more polar layers 14 comprise one or more polyamides, then the bond formed between a polar layer 14 and a tie layer 16 that bonds the polar layer 14 to a non-polar layer 12 can be substantially more stable than for other polar materials such as EVOH. Therefore, each of the one or more polar layers 14 can be formed entirely or substantially entirely with one or more polyamides and each polar layer 14 will, therefore, be referred to herein as a polyamide layer 14 for the sake of brevity.

Examples of polyamide compounds that can be used to form each of the one or more polyamide layers 14 include, but are not limited to: a polyamide comprising polymerized caprolactam, often referred to as “Nylon 6;” a polyamide copolymer of hexamethylenediamine and adipic acid, often referred to as “Nylon 66;” and polyamide copolymers of caprolactam, hexamethylenediamine, and adipic acid, often referred to as “Nylon 6/66.” The use of a generally polar polyamide material can allow the geomembrane 10 to provide a barrier to non-polar materials, including non-polar odor compounds such as odor-producing VOCs and other non-polar odor-producing compounds. Polyamide polar materials are known, however, to have poor barrier properties with respect to polar materials, such as water vapor or polar odor compounds. The combination of the one or more non-polar layer 12, e.g., one or more polyethylene layers 12, and the one or more polyamide layers 14 can allow the geomembrane 10 to provide a barrier to both polar materials, including water vapor and polar odor compounds, and non-polar materials, including non-polar odor compounds such as odor-producing VOCs.

Because the one or more non-polar layers 12 are formed from a non-polar compound, e.g., a polyolefin such as polyethylene, and the one or more polar polyamide layers 14 are formed from a polar compound, e.g., a polyamide, a polyamide layer 14 typically will not bond or join directly with a non-polar layer 12. Two or more polyethylene layers 12 can be joined together simply by coextrusion of the layers such that the different melt layers will co-mix and bond together upon solidificiation. Similarly, two or more polyamide layers 14 can be directly bonded to one another, e.g., by coextrusion or other direct bonding methods. In contrast, a polyethylene layer 12 cannot be coextruded with a polyamide layer 14 or directly bonded to the polyamide layer 14, such as with welding or other direct bonding methods. Therefore, the geomembrane 10 can include one or more tie layers 16 positioned between the one or more non-polar layers 12 and the one or more polyamide layers 14 in order to bond the non-polar layers 12 and the polyamide layers 14. The composition of the one or more tie layers 16 can depend on the corresponding composition of the non-polar layer 12 and the polyamide layer 14 that the tie layer 16 is bonding together. The composition of a particular tie layer 16 can be chosen so that it can form a mechanical bond or chemical bond, or both, with both the non-polar layer 12 and the polyamide layer 14. For example, when the non-polar layer 12 comprise polyethylene and the polyamide layer 14 comprises one of the nylon compounds described above, e.g., at least one of Nylon 6, Nylon 66, and Nylon 6/66, the one or more tie layers 16 can comprise polyethylene grafted with maleic anhydride (MA). The polyethylene of the tie layers 16 can directly bond to the polyethylene of the non-polar layer 12 so that the tie layer 16 will be bonded to the polyethylene layer 12. The maleic anhydride grafts can form bonds, such as amide bonds, with the polyamide of the polyamide layer 14, e.g., so that the geomembrane 10 forms a single structure with all layers 12, 14, 16 bonded together.

In an example, shown in FIG. 1, the geomembrane 10 can comprise a five-layer structure comprising outer non-polar layers 12, e.g., polyethylene layers 12, and one or more inner polyamide layers 14 with one or more tie layers 16 between the polyamide layer 14 and each polyethylene layer 12. Each layer 12, 14, 16 of the geomembrane 10 depicted in FIG. 1 can comprise one or more separate layers of the material forming the layer 12, 14, 16. For example, one or both of the outer polyethylene layers 12 shown in FIG. 1 can comprise two or more co-extruded polyethylene layers that combine to form the polyethylene layer 12. In an example, the non-polar material of the non-polar layers 12 (e.g., a polyolefin such as polyethylene), the polyamide of the polyamide layer 14 (e.g., at least one of Nylon 6, Nylon 66, and Nylon 6/66), and the material of the tie layers 22 (e.g., maleic anhydride grafted polyethylene) can be co-extruded into the film that forms the geomembrane 10 in a co-extrusion die.

In an example, the geomembrane 10 can have an overall thickness of from about 5 mils (about 0.13 millimeters (mm)) to about 120 mils (about 3 mm), such as from about 30 mils (about 0.76 mm) to about 100 mils (about 2.5 mm), such as from about 50 mils (1.3 mm) to about 80 mils (about 2 mm), for example about 60 mils (about 1.5 mm). In an example, the total thickness of the one or more polyamide layers 14 (e.g., the thickness of the single polyamide layer 14 shown in FIG. 1, or the sum of the thicknesses of all the polyamide layers 14 if there are a plurality of polyamide layers 14) is from about 2% to about 30% of the total thickness of the geomembrane 10, such as from about 5% to about 15%, such as about 10% of the total thickness of the geomembrane 10. In an example, each set of one or more tie layers 16, e.g., each group of one or more tie layers 16 between a polyamide layer 14 and a corresponding non-polar layer 12, can have a total thickness of from about 2% to about 10% of the to al thickness of the geomembrane 10, such as from about 4% to about 5%, for example about 5% of the thickness of the geomembrane 10. In an example, the total thickness of all tie layers 16, e.g., all groups of the tie layers 16, can be from about 3% to about 25%, such as about 10% of the total thickness of the geomembrane 10. The balance of the thickness of the geomembrane 10 can be the non-polar layers 12, e.g., the polyethylene layers 12, which can be, for example, from about 45% to about 95% of the thickness of the geomembrane 10, such as from about 70% to about 90%, for example about 80% of the total thickness of the geomembrane 10.

In an example, the one or more non-polar layers 12 can comprise a polyolefin having a base density of from about 0.85 grams per cubic centimeter (g/cm³) to about 0.97 g/cm³, such as from about 0.875 g/cm³ to about 0.939 g/cm³, for example from about 0.91 g/cm³ to about 0.92 g/cm³, such as from about 0.912 g/cm³ to about 0.920 g/cm³, However, the overall density of the non-polar layers 12 can be varied outside of these ranges, for example with the addition of additives, such as stabilizers, colorants, or fillers, which can increase the overall density of a layer 12. In an example, the one or more polyamide layers 14 can comprise a polyamide material, such as one or more of Nylon 6, Nylon 66, and Nylon 6/66, having a base density from about 1 g/cm³ to about 1.5 g/cm³, such as from about 1.1 g/cm³ to about 1.25 g/cm³, such as about 1.17 g/cm³. However, like the one or more non-polar layers 12, the overall density of the one or more polyamide layers 14 can be altered by the addition of stabilizers, colorants, or fillers, in an example, the tie layers 16 can comprise a material having a base density of from about 0.85 g/cm³ to about 1 g/cm³, such as from about 0.875 g/cm³ to about 0.96 g/cm³, for example about 0.91 g/cm³.

In an example, the geomembrane 10 can have a tensile strength of about 95 MPa or more. In an example, the geomembrane has an elongation to break of about 380% or more. In an example, the geomembrane 10 can have a puncture strength of about 82 Mpa or more. In an example, the geomembrane 10 can have a tear strength, as measured by ASTM Standard D1004, of about 29.6 pounds force (lbf) or more. In an example, the geomembrane 10 can have a puncture resistance, as measured by ASTM D4833, of 88.9 lbf or more.

Additives can be added to one or more of the layers 12, 14, 16, if desired. Additives can include at least one of one or more stabilizers, such as phosphate stabilizers or phenolic stabilizers, one or more antioxidants, and one or more pigments. In an example, a UV or other light stabilizer can be added to one or more of the layers 12, 14, 16 of the geomembrane 10 to protect the geomembrane 10 when it is exposed to sunlight for an extended period of time. Examples of UV stabilizers that can he used to UV-stabilize the geomembrane 10 include, but are not limited to: UV stabilizers, sold by BASF SE, of Ludwigshafen, Germany, such as TINUVIN 111, TINUVIN 622, CHIMASORP 119, CHIMASORB 944, CHIMASORB 20202, or some combination thereof for the polyolefin layers 12 or the tie layers 16, or one or more of CHIMASORB 119, CHIMASORB 2020, and CHIMASORB 944 for the one or more polyamide layers 14; CYASORB CYNERGY Solutions UV stabilizers, sold by Cytec industries, Inc., of Woodland Park, N.J., USA, such as CYASORB A430.

The one or more layers 12, 14, 16 can also include one or more antioxidants to promote stability of the materials of the layers 12 14, 16. The term “antioxidant” can refer to a material that can provide for one or more of: the prevention or amelioration of oxidation of the geomembrane 10 (such as of the one or more non-polar layers 12, e.g., one or more polyethylene layers 12, the one or more polyamide layers 14, and/or the one or more tie layers 16); and enhanced UV stability of the geomembrane 10, particularly when combined with a UV stabilizer. Examples of antioxidants that can be used in one or more of the polyolefin layers 12 and the tie layers 16 include, but are not limited to, IRGANOX antioxidant (such as IRGANOX 1010) or IRGAFOS antioxidant (such as IRGAFOS 168) sold by BASF SE, of Ludwigshafen, Germany, such as a mixture of IRGANOX 1010 and IRGAFOS 168. Examples of antioxidants that can be used in the one or more polyamide layers 14 include, but are not limited to, IRGANOX antioxidant (such as IRGANOX 1098) either alone or in a mixture with IRGAFOS antioxidant (such as IRGAFOS 168), or a CYANOX antioxidant sold by Cytec Industries, Inc., of Woodland Park, N.J., USA, such as CYANOX 1790.

In an example, the loading of a UV stabilizer in one or more of the layers 12, 14, 16 can be from about 0.1 wt. % to about 1 wt. %, such as about 0.2 wt. % of the layer or layers 12, 14, 16 in which the UV stabilizer is loaded. The loading of an antioxidant in one or more of the layers 12, 14, 16, can be from about 0.05 wt. % to about 0.5 wt. %, such as about 0.25 wt. % of the layer or layers 12, 14, 16 in which the antioxidant is loaded. In an example, the loading of the UV stabilizer and the antioxidant can he more than 1 wt. % in one or more of the layers 12, 14, 16.

One or more of the layers 12, 14, 16 can comprise, in addition to the materials described above, one or more pigments. In an example, the pigment can comprise a black pigment, such as a carbon black, A carbon black can allow the geomembrane 10 to be black in color. Black color is the most commonly used color for geomembranes because it is a natural UV absorber that can protect the geomembrane from UV degradation when exposed to sunlight. A carbon black pigment can provide for efficient UV stability and weatherability compared to other pigments, in particular when the particle size of the carbon is very small, such as 19 nanometers (nm) or less. In the example of FIG. 1, e.g., where the polyethylene layers 12 are the outer layers of the membrane, one or both of the polyethylene layers 12 can comprise the pigment, such as the carbon black pigment, such as 19 nm carbon black (9A32 grade) sold by Cabot Corp., Boston, Mass., USA.

The pigment of the one or more polyolefin layers 12 and the tie layers 16 can also comprise a white pigment, such as a titanium dioxide (TiO₂) pigment. A white pigment can allow the geomembrane 10 can be white in color, which can provide for relatively minimized heating of the geomembrane 10 when exposed to sunlight. A white-colored geomembrane 10 can also provide for moderate opacity strength. A TiO₂ white pigment can also provide for good UV stability compared to other pigments. TiO₂ pigment can also be made with small particle size, and thus can have better dispersion in plastics. TiO²particles can also be relatively easily coated with silicon or other coatings, which can also provide for good dispersion. In the example of FIG. 1, e.g., where the polyethylene layers 12 are the outer layers of the membrane, one or both of the polyethylene layers 12 can comprise the pigment, such as the white pigment, for example a TiO₂ pigment.

Examples of a white pigment that can be used in the formulation of one or more layers 12, 16 of the geomembrane 10 include, but are not limited to, TiO₂, such as TI-PURE R-105 titanium dioxide, sold by E.I. du Pont de Nemours and Company, of Wilmington, Del., USA. The pigment can be specially designed for outdoor plastics applications (as is the TI-PURE R-105 pigment). For example, the particles of TiO₂ in the pigment can be coated, e.g., with a silicone coating, which can have better UV stability by preventing or limiting the formation of free radicals when the TiO₂ is exposed to UV. In an example, the loading of the pigment in any of the layers 12, 16 can be from about 2 wt. % to about 15 wt. %, wherein the loading of the pigment can depend on the specific pigment used and the thickness of the layer 12, 16 being loaded with the pigment.

The one or more pigments can comprise, in addition to or in place of the white pigments described above, pigments of other colors, including, but not limited to, gray, red (e.g., dark red, light red, or shades of pink), orange, yellow, green (e.g., light green or dark green), blue (e.g., light blue or dark blue), indigo, purple, brown, or tan, or other colors comprising a mixture of two or more of these colors. For example, a gray color can be made with titanium dioxide and a very small percentage of carbon black. A red color can be made with pigment Cadmium Red (cadmium selenide). An orange color can be made with pigment Cadmium Orange (cadmium sulfoselenide). A yellow color can be made with pigment Cadmium Yellow (cadmium sulfide). A green color can be made with pigment Chrome Green (chromic oxide). A blue color can be made with pigment Cerulean Blue (cobal (II) stannate). A purple color can be made with pigment Cobalt Violet (cobaltous orthophosphate). Other colors might be made with mixture of these example pigments. The loading of the pigment or mixture of pigments in the layers 12, 16 of the geomembrane 10 can be from about 0.5 wt. % to about 15 wt. %, wherein the loading of the pigment can depend on the specific pigment(s) used and the thickness of the layer 12, 16 being loaded with the pigment.

The barrier properties of the geomembrane 10 can be defined by the transmission of one or more chemical compounds through the geomembrane 10, such as the transmission of one or more of water vapor and oxygen.

The transmission of water vapor through the geomembrane 10 can be defined as a water vapor transmission rate (WVTR), for example as defined by ASTM standard test method E96 or ASTM standard test method F1249. In an example, a geomembrane 10 tested at 23° C. with 50% relative humidity can have a WVTR of about 2×10⁻³ grams per hour per square meter (g/hr-^{m2}) or less, such as about 1.8×10⁻³ g/hr-^{m2} or less.

The transmission of oxygen gas (O₂) through the geomembrane 10 can be defined as the O₂ transmission rate, for example as described by ASTM standard test D3985. In an example, a geomembrane 10 tested at 23° C. with 90% relative humidity can have an O₂ transmission rate of about 7 cubic centimeters per square meter per day (cm³/m²·day) or less, such as about 6 cm³/m²·day or less. The transmission of O₂ through the geomembrane 10 can also be defined as the O₂ permeation, for example as described by ASTM standard test D3985. In an example, the O₂ permeation through the geomembrane 10 can be about 210 cubic centimeter mils per square meter per day (cm³·mil/m²·day) or less, such as about 195 cm³·mil/m²·day or less.

In an example, these permeability coefficients for the geomembrane 10 can be compared to a similar membrane made just from one or more non-polar layers, such as one or more polyethylene layers (e.g., a LLDPE barrier), which can have an O₂ transmission rate of greater than 200 cm³/m²·day, which is much higher than the geomembrane 10 with the polyamide barrier layer 14.

The geomembrane 10 can have a width that is sufficiently large to provide for coverage of a wastewater treatment pool or other large area without requiring a large number of geomembranes 10 to cover the entire area. In an example, the geomembrane 10 can have a width of from about 5 feet (about 1.5 meters (m)) to about 40 feet (about 12 m), such as about 16 feet (about 4.8 m). In an example, the geomembrane 10 can have a width that is no less than about 10 feet (about 3 m), such as no less than about 15 feet (about 4.5 m), such as no less than about 16 feet (about 4.8 m), such as no less than about 16.5 feet (about 5 m), such as no less than about 20 feet (about 6 in), such as no less than about 25 feet (about 7.6 m).

As mentioned above, the present inventors have discovered that using one or more polyamide materials as the one or more polar layers 14 of the geomembrane 10 can provide substantially longer stability at elevated temperatures and high relative humidity when bonded to a tie layer 16, such as a maleic anhydride-grafted polyethylene tie layer 16, as compared to geomembranes with polar layers made with other materials, such as ethylene vinyl alcohol (EVOH). It has been found that the geomembrane 10 described herein, e.g., with one or more polyamide polar layers 14 bonded to one or more polyethylene non-polar layers 12 by one or more maleic anhydride grafted polyethylene tie layers 16 can withstand substantially harsher conditions than other geomembranes. In an example, such a geomembrane 10 can withstand temperatures of at least 95° C., such as at least 96° C., at least 97° C., at least 98° C., or at least 99° C. The geomembrane 10 can also withstand very high humidity, e.g., as high as at least 90% relatively humidity, e.g., at least 91%, at least 92%, at least 93%, at least 94%, at least 95%, at least 96%, at least 97%, at least 98%, at least 99%, 100% relatively humidity, or even being partially or totally submerged (e.g., with at least one side of the geomembrane 10 in contact with water). In an example, the geomembrane 10 can withstand these temperatures (e.g., at least 95° C. at least 96° C., at least 97 ° C., at least 98° C., or at least 99° C.) and this relative humidity (e.g., at least 90%, at least 91%, at least 92%, at least 93%, at least 94%, at least 95%, at least 96%, at least 97%, at least 98%, at least 99%, 100% relatively humidity), and can do so for relatively long periods of time, e.g., at least about 100 days, for example at least about 140 days, or more. Tests of a geomembrane 10 according to the present disclosure have remained in tact for immersion tests as long as 20 weeks (140 days) or more with no obvious decrease in play adhesion.

In contrast, a similar geomembrane comprising polyethylene outer layers bonded to one or more EVOH inner layers by maleic anhydride grafted polyethylene tie layers have been found to been found to break down, e.g., by hydrolysis of the bonds between the tie layers and the EVOH layer, resulting in delamination and failure of the geomembrane, in as little as about 28 days (4 weeks) when exposed to the same conditions (e.g., temperatures of at least 95° C. and immersion in liquids. For many applications, this would not be a problem because the EVOH-containing geomembrane would not be exposed to such elevated temperatures or humidity. However, because wastewater treatment ponds and processes can often involve wastewater being heated to at least 90° C., and often at least 95° C., the EVOH-containing geomembranes often cannot perform adequately for wastewater applications.

Without wishing to be bound to any theory, the present inventors believe that the chemical bond that forms between a tie layer material, e.g., a maleic anhydride grafted polyethylene tie layer 16, and a polyamide polar layer 14, is substantially stronger and more durable under elevated temperature and elevated humidity than the bond between EVOH and the same tie layer material.

Further data regarding the stability of the geomembrane 10 described herein, e.g., with one or more polyamide polar layers 14, is provided in the Examples shown below.

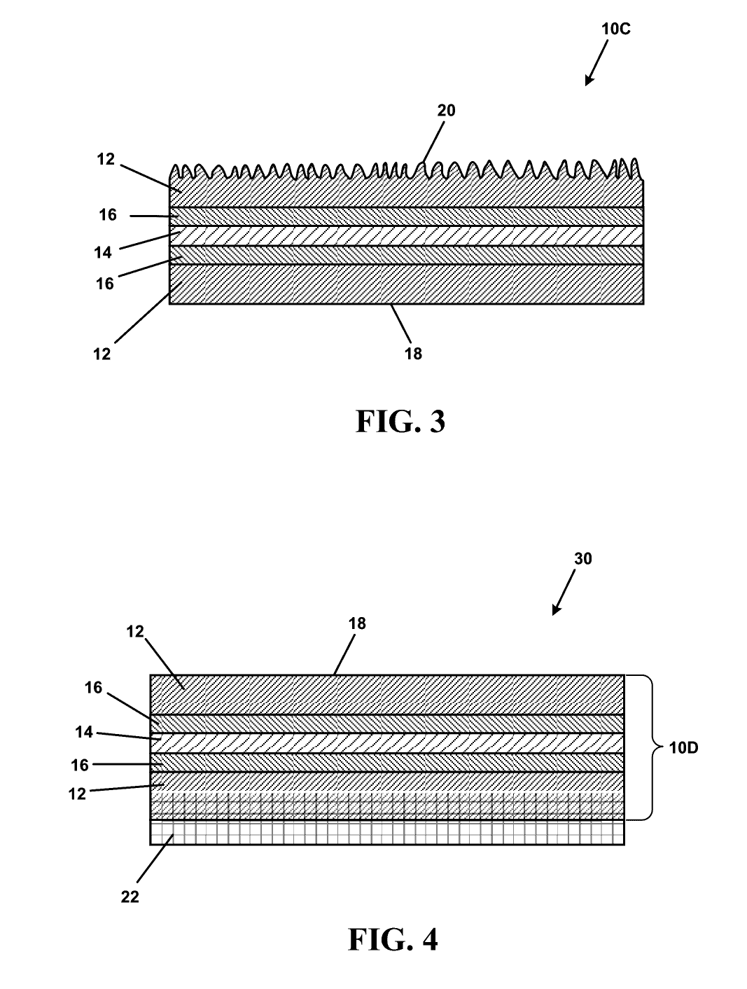

A geomembranes 10 can include smooth surfaces 18 on both sides of the geomembrane 10, as shown in the example of FIG. 1. A geomembrane 10B can include textured surfaces 20 on both sides of the geomembrane 10B, as shown in the example of FIG. 2. A geomembrane 10C can include a smooth surface 18 on one side of the geomembrane 10C and a textured surface 20 on a second side of the geomembrane 10C, as shown in the example of FIG. 3. A textured surface 20 can provide for more friction along the geomembrane 10B, 10C than a smooth surface 18. A textured surface 20 can be formed, for example, by one or more of injecting nitrogen gas in the extruder for the material of the outer layers, e.g., a polyolefin such as polyethylene that can form the outer polyolefin layers 12, during the extrusion or by embossing on a cast extrusion line.

A geomembrane 10D with at least one smooth surface 18 can be used to make a reinforced barrier structure 30, such as via lamination with a reinforcing fabric 22, for example a polyester fabric, as shown in FIG. 4. The reinforcing fabric 22 can be sandwiched between two geomembranes 10D that are hot melted onto the fabric 22, e.g., so that an outer layer of the geomembrane 10D is in contact with the fabric 22. In an example, the fabric 22 can be at least partially embedded in the outer layer of the geomembrane 10D. The fabric 22 can be sandwiched with one geomembrane 10D and one non-barrier polyolefin sheet during a lamination process. The reinforced barrier structure 30 can be made by extruding or casting a polyolefin melt on top of the fabric 22 and the geomembrane 10D.

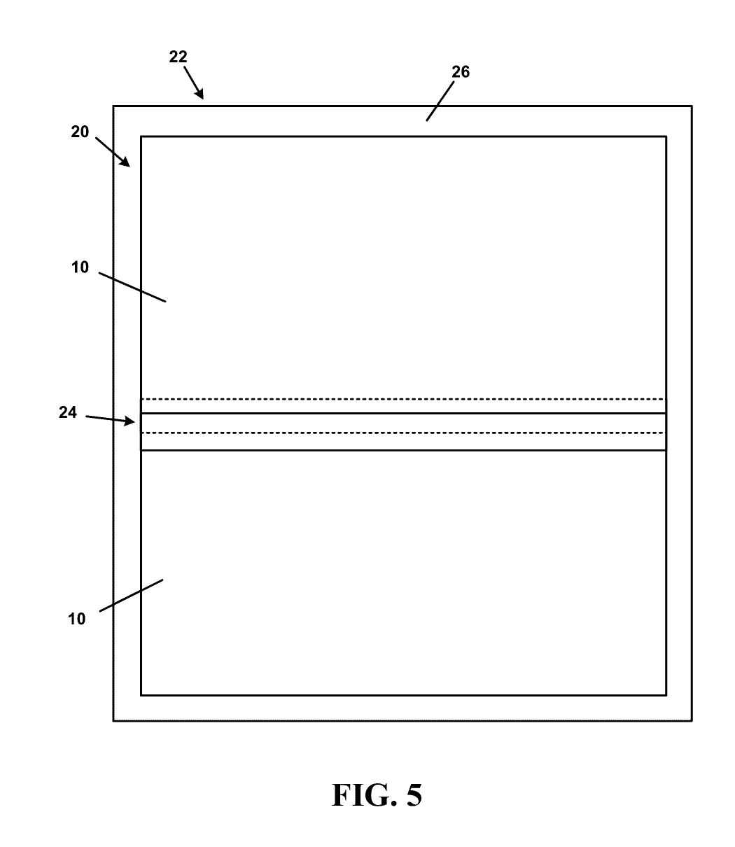

One or more of the geomembranes 10 can be used to cover a structure. For example, one or more of the geomembranes 10 described above can be coupled together to form a barrier structure 20, as shown in FIG. 5. The barrier structure 20 can be used in a method for covering at least a portion of a structure 22. In the example shown in FIG. 5, two geomembranes 10 are coupled together to form the barrier structure 20, which in turn covers a portion of the covered structure 22. The plurality of geomembranes 10 can be coupled together by welding the outer non-polar layers 12 together along a seam 24. However, if the structure 22 being covered is small enough that it can be covered by one geomembrane 10, then a plurality of geomembranes 10 (as in FIG. 5) is not needed. Welding of the outer non-polar layers 12 can comprise contacting one of the non-polar layers 12 of a first geomembrane 10 with one of the non-polar layers 12 of a second geomembrane 10 and then selectively heating the geomembranes 10 so that at least a portion of the one or both of the contacted non-polar layers 12 become molten so that the contacted non-polar layers 12 can be coupled together by the molten and then resolidified non-polar material.

The covered structure 24 that the barrier structure 20 is covering can comprise a pool of water 26, such as a wastewater treatment pool 26. For example, the water 26 can comprise one or more pollutants dissolved therein or can be carrying one or more pollutants. The method can, therefore, further included treating the pool of water 26 to remove or convert the one or more pollutants dissolved in or carried by the water 26.

The presence of the one or more pollutants can emit odor compounds, such as one or more of odor-producing VOCs, hydrogen sulfide, benzene, toluene, dichlorobenzene, and methane. For example, some pollutants can be removed or converted through microbial digestion, which can tend to release odor compounds. Other pollutants include odor compounds as part of their composition, and can tend to release at, least, a portion of the odor compounds into the air. The barrier structure 20 of the one or more geomembranes 10 can prevent or minimize transmission of the odor compounds produced by the presence of the one or more pollutants.

Although the use of the geomembrane 10, 10B, 10C has been described with respect to wastewater treatment, a person of ordinary skill in the art will recognize that the geomembrane 10, 10B, 10C can be used for other applications that may involve the release of odor-producing compounds including, but not limited to: solid waste storage, treatment, or disposal; landfills or other municipal waste storage, treatment, or disposal facilities; and agricultural manure containment, treatment, or disposal facilities.

### EXAMPLES

The present disclosure can be better understood by reference to the following comparative example and illustrative examples which are offered by way of illustration. The present disclosure is not limited to the examples given herein.

### Comparative Example

Geomembranes having an overall thickness of 30 mil (about 0.76 mm) were produced with outer layers (similar to layers 12 in FIG. 1) comprising polyethylene, an inner layer (similar to layer 14 in FIG. 1) comprising EVOH, and a pair of maleic anhydride grafted polyethylene tie layers (similar to layers 16 in FIG. 1) between the outer polyethylene layers and the inner EVOH layer.

### Example 1

Geomembranes having an overall thickness of 30 mil (about 0.76 mm) were produced with outer layers 12 comprising polyethylene, an inner layer 14 comprising Nylon 6/66, and a pair of maleic anhydride grafted polyethylene tie layers 16 between the outer polyethylene layers and the inner Nylon layer.

### Experimental Procedure

A first sample of each type of geomembrane (e.g., the EVOH-based geomembrane of the Comparative Example and the Nylon-based geomembrane of Example 1) was fully immersed in water at 95° C. Another sample of each geomembrane was immersed in an acid bath of hydrochloric acid (HCl) having a pH of about 2 and a temperature of about 95° C. Yet another sample of each geomembrane was immersed in a basic bath of sodium hydroxide (NaOH) having a pH of about 12 and a temperature of about 95° C. Samples of each geomembrane type (Comparative Example and Example 1) from each immersion bath (water, acid, and base) were removed from the baths after various immersion durations and the ply adhesion of the samples were taken. Results of the ply adhesion for the Comparative Example and Example 1 (described b low) are shown in Table 1.

TABLE 1
Immersion Test Results

| | Comparative Example (EVOH) | | | Example 1 (Nylon) | | |
|---|---|---|---|---|---|---|
| Time | Ply Adhesion (lbf) | | | Ply Adhesion (lbf) | | |
| (weeks) | Acid | Water | Base | Acid | Water | Base |
| Start | 27.2 | | | 36.8 | | |
| 1 | 26.1 | 27.3 | 26.5 | 31.0 | 30.4 | 32.5 |
| 2 | 24.5 | 25.3 | 23.9 | 29.1 | 28.6 | 35.2 |
| 3 | 7.5 | 20.9 | 2.2 | 21.6 | 37.6 | 29.5 |
| 4 | 1.0 | 0.8 | 0.9 | 26.0 | 27.0 | 33.4 |
| 5 | delaminated | delaminated | delaminated | 34 | 35.3 | 32.9 |
| 15 | delaminated | delaminated | delaminated | 29.2 | 28.5 | 28.7 |

As can be seen in Table 1, the ply adhesion of the EVOH-based geomembranes of Comparative Example 1 began to degrade somewhere between 2 weeks and 3 weeks. By week 3, the ply adhesion declined about 23% from the starting adhesion for the water bath, about 72% for the acid bath, and about 92% for the base bath. By week 4, the EVOH-based geomembranes all three baths had lost nearly all adhesion strength, with the geomembranes having declined to 2.9%, 3.7%, and 3.3% of their starting ply adhesion strengths for the water bath, the acid bath, and the base bath, respectively. By 5 weeks, all three geomembrane samples of the Comparative Example had completely delaminated.

In contrast, the Nylon-based geomembranes of Example 1 not only had a starting adhesion strength that is 35% higher than that of the EVOH-based geomembrane of the Comparative Example, but, as shown in Table 1, the geomembranes of Example 1 also maintained the ply adhesion much better. For example, at 3 weeks in the water bath the ply adhesion had actually increased by about 2% (likely due to experimental error). At week 3, both the acid bath and base bath geomembrane had declined (by about 20% for the base bath and 41% for the acid bath), but it is believed that this was due to experimental error as well, as the ply adhesion of both the acid bath and base bath geomembranes seemed to increase at Week 4 and Week 5. After 15 weeks, the ply adhesion of the geomembranes of Example 1 had only decreased by about 22.5%, about 21%, and about 22% for the water bath, acid bath, and the base bath, respectively. There was also no apparent trend toward failure by delamination for the geomembranes of Example 1 over time. In contrast, the geomembranes of the Comparative Example showed a clear downward progression toward failure almost immediately.

Table 2 shows some basic mechanical properties of two example smooth geomembranes made according to EXAMPLE 1. The smooth geomembranes of Table 2 had thicknesses of 30.3 mil (Sample A) and 62.9 mil (Sample B). The two geomembranes were produced with outer layers comprising medium density polyethylene (having a density of from 0.930 g/cm³ to 0.943 g/cm³), an inner layer comprising Nylon 6/66, and a maleic anhydride grafted polyethylene tie layer between the inner Nylon 6/66 layer and each of the the outer polyethylene layers. Both Sample A and Sample 8 show very good tensile strength, elongation at break, graves tear, and puncture properties.

TABLE 2
Geomembrane Mechanical Properties

| Property (units) | ASTM Method | Sample A | Sample B |
|---|---|---|---|
| Thickness (mil) | D5199 | 30.3 | 62.9 |
| Tensile Strength (MPa) | | | |
| at Yield | D6693 | 20.7 | 19.4 |
| at Break | | 23.3 | 20.9 |
| Elongation (%) | | | |
| at Yield | D6693 | 13% | 17% |
| at Break | | 382% | 444% |
| Graves Tear (gram) | D1004 | 13426 | 23587 |
| Puncture (N) | D4833 | 395 | 599 |

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), to allow the reader to quickly ascertain the nature of the technical disclosure. It is submitted with the understanding that it will not he used to interpret or limit the scope or meaning of the claims.

Although the invention has been described with reference to exemplary embodiments, workers skilled in the art will recognize that changes may be made in form and detail without departing from the spirit and scope of the invention.

What is claimed is:

1. A geomembrane comprising:
one or more non-polar layers formed predominantly from a non-polar material;
at least one polyamide polar layer formed predominantly from a polyamide material; and
at least one tie layer disposed on either side of the at least one polyamide polar layer and between the one or more non-polar layers and the at least one polyamide polar layers, wherein each tie layer bonds to one of the one or more non-polar layers and to one of the at least one polyamide polar layer.

2. The geomembrane according to claim 1, wherein the non-polar material of the one or more non-polar layers comprises polyethylene.

3. The geomembrane according to claim 1, wherein the geomembrane is stable when exposed to a temperature of at least 95° C. and a relative humidity of at least 90% for at least 20 weeks.

4. The get membrane according to claim 1, wherein a thickness of the one or more polyamide polar layers is from about 2% to about 30% of a total thickness of the geomembrane.

5. The geomembrane according to claim 1, wherein a thickness of the one or more non-polar layers is from about 45% to about 95% of the thickness of the geomembrane.

6. The geomembrane according to claim 1, wherein an overall thickness of the geomembrane is from about 5 mils to about 120 mils.

7. The geomembrane according to claim 1, wherein the geomembrane comprises one of: a smooth surface on each outer layer of the geomembrane; a textured surface on each outer layer of the geomembrane; or a smooth surface on a first outer layer of the geomembrane and a textured surface on a second other outer layer of the geomembrane.

8. The geomembrane according to claim 1, further comprising a reinforcing fabric in contact with an outer layer of the geomembrane.

9. A geomembrane comprising:
a pair of non-polar layers formed predominantly from polyethylene;
at least one polyamide polar layer positioned between the pair of non-polar layers; and
at least one tie layer disposed on either side of the at least one polyamide polar layer, each tie layer being positioned between the at least one polyamide layer and a corresponding one of the pair of non-polar layers, wherein each tie layer comprises a maleic anhydride-grafted polyethylene that bonds to the polyethylene of the non-polar layer and to the at least one polyamide layer.

10. The geomembrane according to claim 9, wherein the geomembrane is stable when exposed to a temperature of at least 95° C. and a relative humidity of at least 90% for at least 20 weeks.

11. The geomembrane according to claim 9, wherein the geomembrane comprises one of: a smooth surface on each outer layer of the geomembrane; a textured surface on each outer layer of the geomembrane; or a smooth surface on a first outer layer of the geomembrane and a textured surface on a second other outer layer of the geomembrane.

12. The geomembrane according to claim 9, further comprising a reinforcing fabric in contact with an outer layer of the geomembrane.

13. A method of providing a barrier for odor control, the method comprising:
covering a pool of water with one or more geomembranes so that the one or more geomembranes are in contact with at least a portion of the pool of water, wherein the pool of water has a temperature of at least 95° C. for at least a portion of the time that it is covered by the one or more geomembranes;
each of the one or more geomembranes comprising;
one or more non-polar layers formed predominantly from a non-polar material,
at least one polyamide polar layer formed predominantly from a polyamide material; and
at least one tie layer disposed on either side of the at least one polyamide polar layer and between the one or more non-polar layers and the at least one polyamide polar layer, wherein each tie layer bonds to one of the one or more non-polar layers and to one of the at least one polyamide polar layer.

14. The method according to claim 13, wherein the pool of water has a temperature of at least 90° C., and wherein the one or more geomembranes are stable when exposed to the at least 90° C. temperature of the pool of water for at least 20 weeks.

15. The method according to claim 13, wherein the pool of water comprises one or more pollutants, the method further comprising treating the pool of water to remove at least one of the one or more pollutants.

16. The method according to claim 15, wherein the treating of the pool of water to remove the at least one of the one or more pollutants increases the temperature of the pool of water to at least 90° C.

17. The method according to claim 15, wherein the one or more pollutants comprises at least one of: hydrogen sulfide, benzene, toluene, dichlorobenzene, and methane.

18. The method according to claim 13, wherein a thickness of the one or more polyamide polar layers of each of the one or more geomembranes is from about 2% to about 30% of a total thickness of the geomembrane.

19. The method according to claim 13, wherein a thickness of the one or more non-polar layers of each of the one or more geomembranes is from about 45% to about 95% of the thickness of the geomembrane.

20. The method according to claim 13, wherein an overall thickness of each of the one or more geomembrane is from about 5 mils to about 120 mils.
